(19) United States
(12) Patent Application Publication
(10) Pub. No.: US 2004/0085746 A1
(43) Pub. Date: May 6, 2004

(54) Instrument panel with colorful illumination

(76) Inventor: Shih Ling Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/287,644

(22) Filed: Nov. 5, 2002

(51) Int. Cl. G01D 11/28

(52) U.S. Cl. 362/26; 362/489; 362/31; 362/545; 362/800

(57) ABSTRACT

An instrument panel includes a transparent base board interposed between an indicator board on which indicator needles are movably mounted and a transparent cover. The base board defines a number of recesses for respectively and movably accommodating the indicator needles therein. Patterns, such as characters, digitals, scales and figures, are formed on the base board by means of CO₂ etching. The base board defines a number of slots in an end thereof for receiving illuminators, such as light emitting diodes, which give off lights of different colors and intensities. The illuminators are connected to and controlled by a control circuit. A sensor is mounted to an automobile for detection of an operation parameter of the automobile and applies the operation parameter to the control circuit. The control circuit drives the illuminators to give off lights of different colors and intensities for lighting the patterns and indicating different abnormal conditions when the sensor detects abnormal conditions of the automobile.

### BACKGROUND OF THE INVENTION

1. Field of the Invention

The present invention relates generally to an instrument panel of automobiles, and in particular to an instrument panel having an illuminating device capable to light the instrument panel with light of different colors for indication of abnormal conditions of the automobiles.

2. The Related Art

Instrument panels are adopted in almost all kinds of measuring devices to show readings of measurement to an observer. Examples of the instrument panels include a vehicle instrument panel and a control panel of an automatic system. Most of the vehicle instrument panels that are currently available in the market are incorporated with an illuminating device comprising a light source, such as a light bulb, for illuminating the readings. A different vehicle instrument panel includes a cold light board that is adjustable in brightness.

The conventional instrument panels can provide light of fixed color to light the readings of indicator needles. No other measure is employed to provide further information to an observer. For example, overheating of the coolant of the radiator, insufficiency of oil and running out of fuel are just indicated by the corresponding readings on the instrument panel with the indication needles. No particular warning or alarm is given off to the observers.

Thus, it is desired to have an instrument panel that provides particular warnings to an observer in order to effectively remind the observer of abnormal conditions of the vehicle.

### SUMMARY OF THE INVENTION

An object of the present invention is to provide an instrument panel that may selectively illuminate the readings with light of different colors to indicate abnormal conditions.

Another object of the present invention is to provide an instrument panel that can effectively remind an observer of abnormal conditions for safety and security purposes.

To achieve the above objects, in accordance with the present invention, there is provided an instrument panel comprising a transparent base board interposed between an indicator board on which indicator needles are movably mounted and a transparent cover. The base board defines a number of recesses for respectively and movably accommodating the indicator needles therein. Patterns, such as characters, digitals, scales and figures, are formed on the base board by means of CO₂ etching. The base board defines a number of slots in an end thereof for receiving illuminators, such as light emitting diodes, which give off lights of different colors and intensities. The illuminators are connected to and controlled by a control circuit. A sensor is mounted to an automobile for detection of an operation parameter of the automobile and applies the operation parameter to the control circuit. The control circuit drives the illuminators to give off lights of different colors and intensities for lighting the patterns and indicating different abnormal conditions when the sensor detects abnormal conditions of the automobile.

### BRIEF DESCRIPTION OF THE DRAWINGS

The present invention will be apparent to those skilled in the art by reading the following description of preferred embodiments thereof, with reference to the attached drawings, in which:

FIG. 1 is a schematic plan view of an instrument panel constructed in accordance with a first embodiment of the present invention;

FIG. 2 is an exploded view of the instrument panel of the present invention;

FIG. 3 is a cross-sectional view of the instrument panel of the present invention in an exploded form; and

FIG. 4 is a schematic plan view of an instrument panel constructed in accordance with a second embodiment of the present invention.

### DETAILED DESCRIPTION OF THE PREFERRED EMBODIMENT

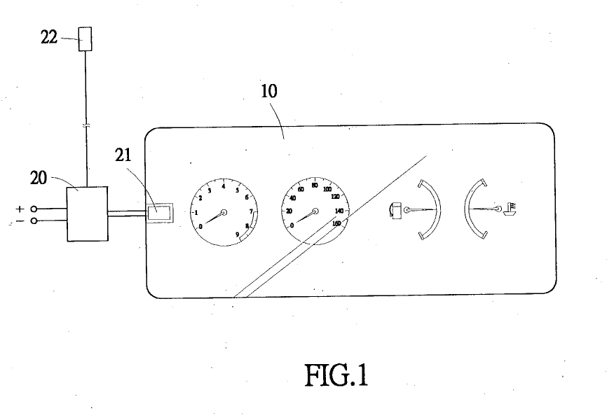

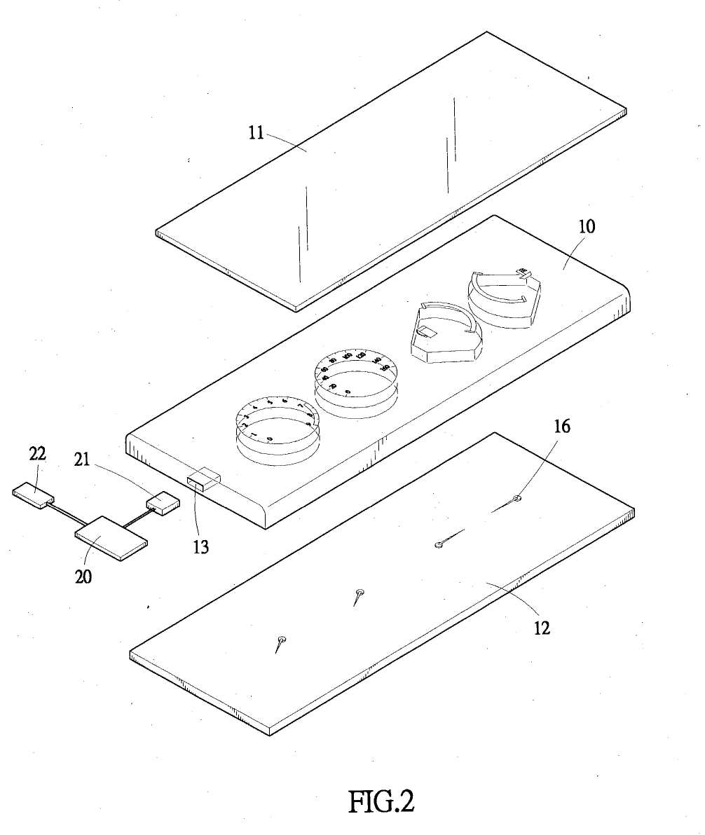

With reference to the drawings and in particular to FIGS. 1 and 2, an instrument panel constructed in accordance with the present invention comprises a base board 10 and a circuit board 20. The instrument panel of the present invention can be employed in an automobile to particularly indicate abnormal conditions of the automobiles with lights of different colors and thus effectively reminding the driver of the abnormal conditions.

The base board 10 is a transparent or light-transmitting board interposed between an indicator board 12 on which a number of indicator needles 16 for indicating readings of different functions are movably mounted and a transparent cover board 11 of a conventional vehicle instrument panel.

The base board 10 defines a slot 13 in an end thereof for receiving an illuminator 21. The illuminator 21 that is received in the slot 13 gives off a light of a predetermined color that is different from the light generated by a light source of the original instrument panel. An example of the illuminator 21 is a light emitting diode (LED) The illuminator 21 is connected to and controlled by a control circuit of the circuit board 20. The light from the illuminator 21 is conducted throughout the whole board 10.

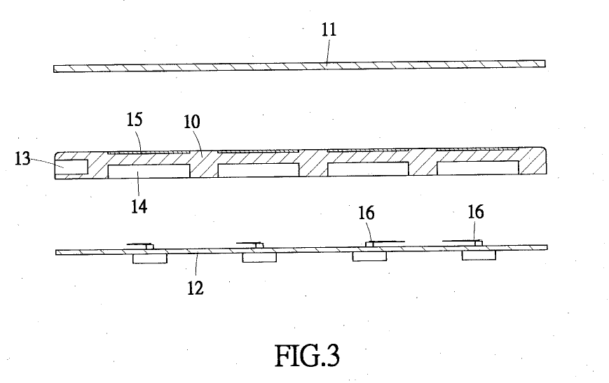

Also referring to FIG. 3, the base board 10 also defines a number of recesses 14 in a surface thereof corresponding in position and number to the indicator needles 16. The recesses 14 accommodate the indicators 16 and allow for movement of the indicator needles 16 therein. Patterns 15 are formed on the base board 10 by means of, such as CO₂ etching techniques. The patterns 15 may include digitals, characters, figures, scales and marks, but not limited thereto. When an observer views the instrument panel, the movement of the indicator needles 16 is substantially corresponding to the scales 15 of the base board 10.

A sensor 22 is connected to the circuit board 20. The sensor 22 is arranged to detect a parameter of an operation condition of the vehicle, such as engine speed, engine temperature, amount of oil and liquid level of fuel in a fuel tank. The sensor 22 may be coupled to a sensor that is originally installed in or integrated with system the vehicle for obtaining a detection signal of the parameter from the original sensor. When an abnormal condition or a predetermined condition is detected by the sensor 22 with the detected signal falling within a range of abnormality, the sensor 22 provides a signal to the circuit board 20 which in turn drives the illuminator 21 to give off light. The light from the illuminator 21 is transmitted through the base board 10 for lighting the patterns 15 of the base board 10. The predetermined color of the light from the illuminator 21 provides a significant change to the general view of the instrument panel and thus effectively reminding the observer of the abnormal condition detected by the sensor 22.

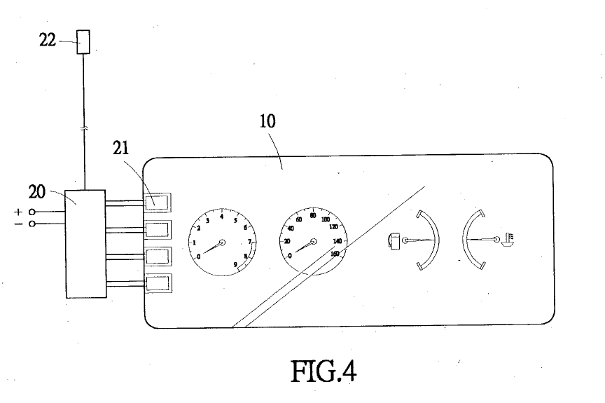

FIG. 4 shows a second embodiment of the instrument panel of the present invention in which a number of slots are defined in the end of the board 10 to accommodate a number of illuminators 21 that give off lights of different colors and different intensities for reminding the observer of different abnormal conditions of the vehicle. Different colors may be used to indicate different abnormal conditions, while different intensities may be used to indicate different extents of abnormality. For example, when the vehicle is overheated, the higher the temperature is, the greater the intensity of the light from the illuminators 21 is.

Other modifications may also be apparent to those skilled in the arts. For example, only parts of the indicators are provided with the colorful illumination. The patterns 15 may be formed in locations different from those corresponding to the indicator needles 16.

Although the present invention has been described with reference to the preferred embodiments with reference to the drawings thereof, it is apparent to those skilled in the art that a variety of modifications and changes may be made without departing from the scope of the present invention which is intended to be defined by the appended claims.

What is claimed is:

1. An instrument panel comprising:
a light-transmitting board adapted to be interposed between an indicator board and a transparent cover, at least one slot being defined in an end of the light-transmitting board, patterns being formed on a surface of the board;
an illuminator received in the slot;
a circuit board forming a control circuit to which the illuminator is electrically connected; and
a sensor adapted to obtain a detected parameter and applying the detected parameter to the control circuit;
wherein when the detected parameter is within a predetermined range, the control circuit drives the illuminator to give off light which is conducted through the light-transmitting board and lighting the patterns.

2. The instrument panel as claimed in claim 1, wherein the illuminator comprises a light emitting diode.

3. The instrument panel as claimed in claim 1, wherein at least one recess is defined in the board, adapted to accommodate movement of an indicator needle movably mounted on the indicator board.

4. The instrument panel as claimed in claim 1, wherein the patterns selectively comprise characters, digitals, scales and figures.

5. The instrument panel as claimed in claim 1, wherein the base board forms a plurality of slots at the end each receiving and accommodating an illuminator therein, the illuminators being electrically connected to the control circuit of the circuit board.

6. The instrument panel as claimed in claim 1, wherein the instrument panel is mounted in an automobile, wherein the sensor is electrically coupled to a detector of the automobile to obtain an operation parameter of the automobile and wherein when the operation parameter is of an abnormal value, the illuminator gives off the light to indicate the abnormality.

7. The instrument panel as claimed in claim 1, wherein the patterns are formed by etching.

8. The instrument panel as claimed in claim 7, wherein the patterns are formed by CO₂ etching.
